(19) United States
(12) Patent Application Publication
(10) Pub. No.: US 2003/0093794 A1
(43) Pub. Date: May 15, 2003

(54) Method and system for personal information retrieval, update and presentation

(75) Inventors: McGee Thomas, Garrison, NY (US); Zimmerman John, Ossining, NY (US); Li Dongge, Ossining, NY (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/014,196

(22) Filed: Nov. 13, 2001

(51) Int. Cl. H04N 5/445; H04N 7/173

(52) U.S. Cl. 725/46; 725/109; 725/133

(57) ABSTRACT

An information retrieval system and method are provided. Content from various sources, such as television, radio and/or Internet, are analyzed for the purpose of determining whether the content matches a predefined user profile, which corresponds to a manually or automatically created personalized information source. The personalized information source is then automatically created to permit access to the information in audio, video and/or textual form. In this manner, the universe of searchable media content can be narrowed to only those programs of interest to the user. Information retrieval can be accomplished through a PDA, radio, computer, MP3 player, television and the like. Thus, the universe of media content sources is narrowed to a personalized set.

### BACKGROUND OF INVENTION

The invention relates to an information retrieval and organization system and method and, more particularly, to a system and method for retrieving, processing and presenting, (in the form of creating a personalized information source) content from a variety of sources, such as radio, television or the Internet.

There are now a huge number of available television channels, radio signals and an almost endless stream of content accessible through the Internet. However, the huge amount of content can make it difficult to find the type of content a particular viewer might be seeking and, furthermore, to personalize the accessible information at various times of day.

Radio stations are generally particularly difficult to search on a content basis. Television services provide viewing guides and, in certain cases, a viewer can flip to a guide channel and watch a cascading stream of program information that is airing or will be airing within various time intervals. The programs listed scroll by in order of channel and the viewer has no control over this scroll and often has to sit through the display of scores of channels before finding the desired program. In other systems, viewers access viewing guides on their television screens. These services generally do not allow the user to search for particular content within a television shown such as a segment a television show. For example, the viewer might only be interested in the sports segment of the local news broadcast.

On the Internet, the user looking for content can type a search request into a search engine. However, search engines can be inefficient to use and frequently direct users to undesirable or undesired websites. Moreover, these sites require users to log in and waste time before desired content is obtained.

U.S. Pat. No. 5,861,881, the contents of which are incorporated herein by reference, describes an interactive computer system which can operate on a computer network. Subscribers interact with an interactive program through the use of input devices and a personal computer or television. Multiple video/audio data streams may be received from a broadcast transmission source or may be resident in local or external storage. Thus, the '881 patent merely describes selecting one of alternate data streams from a set of predefined alternatives and provides no method for searching information relating to a viewer's interest to create a personalized information source for receiving information.

WO 00/16221, titled Interactive Play List Generation Using Annotations, the contents of which are incorporated herein by reference, describes how a plurality of user-selected annotations can be used to define a play list of media segments corresponding to those annotations. The user-selected annotations and their corresponding media segments can then be provided to the user in a seamless manner. A user interface allows the user to alter the play list and the order of annotations in the play list. Thus, the user interface identifies each annotation by a short subject line.

Thus, the '221 publication describes a completely manual way of generating play lists for video via a network computer system with a streaming video server. The user interface provides a window on the client computer that has a dual screen. One side of the screen contains an annotation list and the other is a media screen. The user selects video to be retrieved based on information in the annotation. However, the selections still need to be made by the user and are dependent on the accuracy and completeness of the interface.

EP 1 052 578 A2, titled Contents Extraction Method and System, the contents of which are incorporated herein by reference, describes a user characteristic data recording medium that is previously recorded with user characteristic data indicative of preferences for a user. It is loaded on the user terminal device so that the user characteristic data can be recorded on the user characteristic data recording medium and is input to the user terminal unit. In this manner, multimedia content can be automatically retrieved using the input user characteristics as retrieval keyboard identifying characteristics of the multimedia content which are of interest to the user. A desired content can be selected and extracted and be displayed based on the results of retrieval.

Thus, the system of the '578 publication searches content in a broadcast system or searches multimedia databases that match a viewer's interest. There is no description of segmenting video and retrieving sections, which can be achieved in accordance with the invention herein. This system also requires the use of key words to be attached to the multimedia content stored in database or sent in the broadcast system. Thus, it does not provide a system which is free of the use of key words sent or stored with the multimedia content. It does not provide a system that can use existing data, such as closed captions or voice recognition to automatically extract matches. The '578 reference also does not describe a system for extracting pertinent portions of a broadcast, such as only the local traffic segment of the morning news.

Accordingly, there does not exist fully convenient systems and methods for permitting a user to search through only media content satisfying his personal interests.

### SUMMARY OF THE INVENTION

Generally speaking, in accordance with the invention, an information retrieval system and method are provided. Content from various sources, such as television, radio and/or Internet, are analyzed for the purpose of determining whether the content matches a predefined user profile, which corresponds to a manually or automatically created user information source. The personalized information source is then automatically created to permit access to the information in audio, video and/or textual form. In this manner, the universe of searchable media content can be narrowed to only those programs or sections or segments of programs of interest to the user. Information retrieval can be accomplished through a PDA, radio, computer, MP3 player, television and the like. Thus, the universe of media content sources is narrowed to a personalized set. For example, a user can receive not just weather or traffic, but the most relevant weather or traffic. In addition, the system can change the analysis based on interests of a user, for example, in the morning, showing current traffic and in the evenings traffic alerts for the next day. The system could also be able to automatically detect user interests at particular times and deliver information in accordance with usage, e.g., weather first.

Accordingly, it is an object of the invention to provide an improved system and method for organizing, retrieving and viewing media content on an automatic personalized basis.

The invention accordingly comprises the several steps and the relation of one or more of such steps with respect to each of the others, and the system embodying features of construction, combinations of elements and arrangements of parts which are adapted to effect such steps, all as exemplified in the following detailed disclosure, and the scope of the invention will be indicated in the claims.

### BRIEF DESCRIPTION OF THE DRAWINGS

For a fuller understanding of the invention, reference is made to the following description, taken in connection with the accompanying drawings, in which:

FIG. 1 is a block diagram of a system for retrieving, processing and displaying information in connection with a preferred embodiment of the invention;

FIG. 2 is a flow chart depicting a method of retrieving and processing information in accordance with a preferred embodiment of the invention; and

FIG. 3 is a depiction of how information could be presented in accordance with a preferred embodiment of the invention.

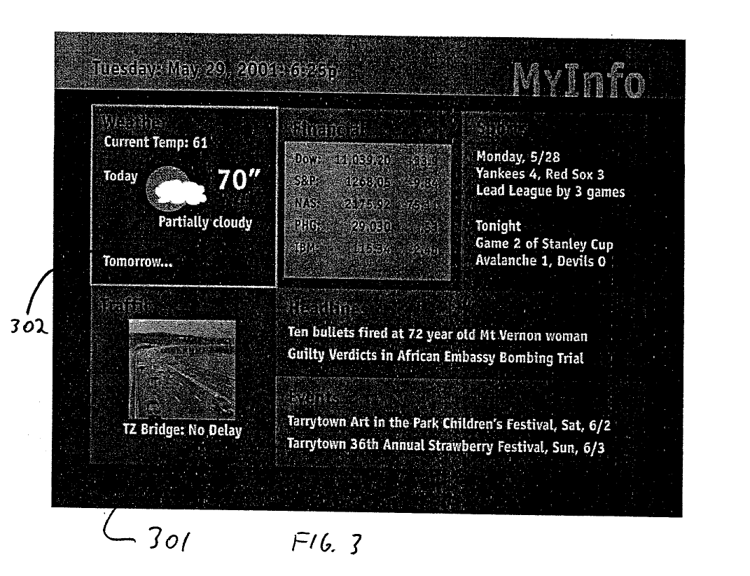

### DETAILED DESCRIPTION OF THE PREFERRED EMBODIMENTS

The present invention is directed to a system and method for retrieving information from multiple media sources according to a preselected or automatic profile of a user, to provide instantly accessible information in accordance with a personalized information source that can be automatically updated with the most current data so that the user has instant access to the most currently available data (programming). This data can be collected from a variety of sources, including radio, television and the Internet. After the data is collected, it can be made available as video, audio, and/or text for viewing or listening or reading or downloaded, for example, as a portion of a program to a computer or other storage media and a user can further download information from that set of data.

A user can provide a profile, which can be manually or automatically generated. For example, a user can select each of the elements of the profile or select such as by clicking on a screen or pushing a button from a preselected set of profiles such as sports, news, movies, weather and so forth. This can also be done automatically. The programs selected can be analyzed and elements of the analysis can be used to edit the profile. A computer can then search television, radio and/or Internet signals to find items that match the profile. After this is accomplished, a personalized information source can be created for accessing the information in audio, video or textual form. This information source can be routinely updated with the most current information if newer and at least as complete (not a less complete subset). Information retrieval can then be accomplished by a PDA, radio, computer, television, VCR, TIVO, MP3 player and the like.

Thus, in one embodiment of the invention, a user types in or clicks on various profile interest selections with a computer or on screen with an interactive television system. Speech interface, gestures and other methods of interaction can be employed. The selected content is then searched for, located and downloaded for later viewing and/or made accessible to the user for immediate viewing so that a much smaller universe of option need be assessed prior to making a viewing selection. For example, if a viewer only wants to watch a movie, typing in MOVIE could be used to narrow his viewing selections to those stations showing movies. Alternatively, the user could have as accessible all of the movies aired during that day, week or other predetermined period.

One specific non-limiting example would be for a user to define his profile as including weather, traffic, stock market, sports and headline news from various sources. A user could also include geographic and temporal information in the profile. The best source of traffic information might be a local radio station which could provide updates every ten minutes. Stock market information might be best accessed from various financial or news websites and weather information could be retrieved from an Internet site dedicated to weather reports, local morning news broadcast or a local morning radio broadcast. This information would be compiled and made accessible to the user, who would not have to flip through potentially hundreds of channels, radio stations and Internet sites, but would have information matching his preselected profile made directly available automatically. Moreover, if the user wanted to drive to work but has missed the broadcast of the local traffic report, he could access and play the traffic report back. Also, he could obtain a text summary of the information or a synthetic announcer reading the text or download the information to an audio system, such as an MP3 storage device for later listening. He could then listen to the traffic report that he had just missed after getting into his car.

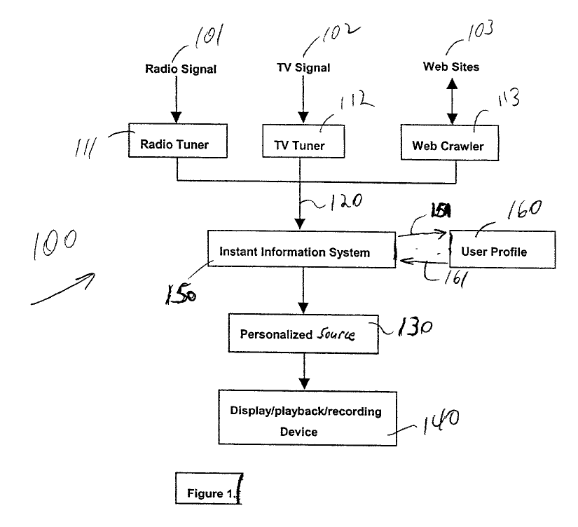

Turning now to FIG. 1, a block diagram of a system 100 is shown for receiving information, processing the information and making the information available to a user, in accordance with a non-limiting preferred embodiment of the invention. As shown in FIG. 1, system 100 is constantly receiving input from various broadcast sources. Thus, system 100 receives a radio signal 101, a television signal 102 and a website information signal via the Internet 103. Radio signal 101 is accessed via a radio tuner 111. Television signal 102 is accessed via a television tuner 112 and website signal 103 is accessed via a web crawler 113.

The type of information received would be received from all areas, and could include newscasts, sports information, weather reports, financial information, movies, comedies, traffic reports and so forth. A multi-source information signal 120 is then sent to instant information processor 150 which is constructed to analyze the signal to extract identifying information as discussed above and send a signal 151 to a user profile comparison processor 160. User profile processor 160 compares the identifying criteria to the profile and outputs a signal 161 indicating whether or not the particular content source meets the profile. Profile 160 can be created manually or selected from various preformatted profiles.

If the information does not match the profile, it is given a low priority in terms of user interest and system 100 continues the process of extracting additional information from the next source of content. It is possible, in connection with certain embodiments of the invention, that sufficiently high broadcaster importance will make this a high priority item. Thus, in certain embodiments of the invention, when there is no match to the profile, content is not discarded so much as it is prioritized. Content is “thrown away” when it is redundant, or when space is needed, the lowest priority information is discarded.

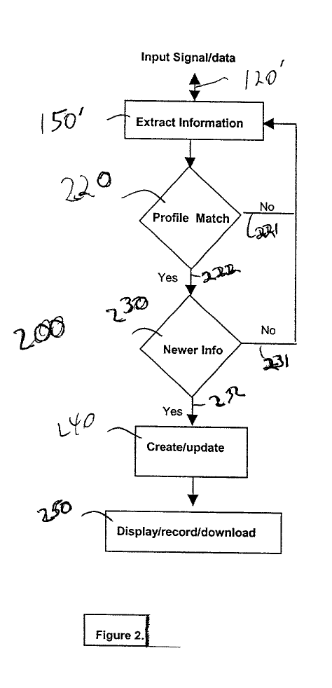

One preferred method of processing received information and comparing it to the profile is shown more clearly as a method 200 in the flowchart of FIG. 2. In method 200, an input signal 120′ is received from various content sources. In a step 150′, an instant information system 150 (FIG. 1), which could comprise a buffer and a computer, extracts information via closed-captioned information, audio to text recognition software and so forth and performs key word searches automatically. For example, if instant information system 150 detected the word “weather”, plus a location and also possibly a time of day in the closed caption information associated with a television broadcast or the tag information of a website, it would make that broadcast or website available for selection as part of the personalized information source.

In a step 220, the extracted information (signal 151 from step 220) is then compared to the user's profile. If the information does not match the user's interest 221, it is disregarded and the process of extracting information 150′ continues with the next source of content. When a match is found 222, the information is checked in step 230 to determine whether the information is more current and not a subset than what already exists in the personalized information source. If the information contained in the signal shows that it is older 231, it is disregarded and extraction process 150′ continues. If newer information checking step 230 shows that the information is newer 232, system 100 replaces the older information in the personalized information source or creates a new source of information in a step 240.

The system can also rate the profile matches and deliver these in a sequence based on user interest. The system can also analyze broadcaster importance placed on a segment, such as sequence in the broadcast and segment duration. The system can also define importance such as “China”. The system then presents information in sequence based not only on user interest (segment, about politics in China), but the importance of a segment to the broadcaster (lead stories with high duration). By way of another example, if a user is interested in the Yankees, the system can look outwards (both forwards and backwards) and present yesterday's score prior to last week's score and information about tomorrow's game before news of last week's game. With respect to traffic, there will be a broadcaster importance (described below), a user importance (described below) and a date. For traffic, future events and currents events are more important than past events. These could all be taken into consideration to set the sequence of presentation.

Finally, in a step 250, the personalized information source selection is available; the user can then view a selected portion, download other portions for later viewing and/or record portions.

Thus, a user profile 160 is used to automatically select appropriate signals 120 from the various content sources 111, 112 and 113, to create a personalized information source 130 containing all of the various sources which correspond to the desired information. System 100 can also include various display and recording devices 140 for recording this information for later playback and/or displaying the information immediately. System 100 can also include downloading devices, so that information can be downloaded to, for example, a videocassette, an MP3 storage device, a PDA or any of various other storage/playback devices.

Furthermore, any or all of the components can be housed in a television set. Also, a dual or multiple tuner device can be provided, having, one tuner for scanning and/or downloading and a second for current viewing.

In one embodiment of the invention, all of the information is downloaded to a computer and a user can simply flip through various sources until one is located which he desired to display.

In certain embodiments of the invention, storage/playback/download device can be a centralized server, controlled and accessed by a user's personalized profile. For example, a cable television provider could create a storage system for selectively storing information in accordance with user defined profiles and permit users to watch what they want, when they want it.

In one embodiment of the invention, a computer system such as a master server monitors all TV news programs. The master server can be at a remote location from the user. It analyzes each program and breaks them down into individual stories or data. For each story or piece of data it can produce metadata that describes various categories, including the following:

1. Classification: Stories and data are classified as, for example, Weather, Financial News, Sports, Traffic, Headlines, and Local Events.

2. Participants: Names of people, companies, products, etc. involved in the story.

3. Event: Summary description of the story event

4. Outcome: Ramifications based on this event

5. Location: Where the event happened or what location is affected by the outcome.

6. Time Sensitivity: Time at which the vent occurred.

7. Broadcaster Importance: Rating of how important the broadcaster felt the story was, based on the location in a news cast or on a website, segment length, and the presence of a preview indicating this story is coming up.

A client system, which can be part of a system including the master server, or which is constructed to receive a data transmission from the master server, receives a transmission of the news broadcast and the metadata and in one embodiment of the invention, stores them. The client system can also check the Internet for news stories and news data. Like the server, the client can produce metadata that describes the stories and data it analyses.

In one embodiment of the invention, the client system then attempts to match stories to the user profile. It can generate a score based on how close a story matches the user's profile based on how information requests match to Participants, Outcomes, and Locations. Next, the client produces a score based on Time Sensitivity and Classification. It ranks the stories and data based on when the information is taking place, but these rankings can be different based on the classification of the story. For example Sports scores from the prior day could be considered as important as sporting events happening the next day. However, traffic information from the prior day could be considered much less important than traffic predictions for the next day. Time sensitivity is also based on the user's habits. For example traffic information about the commute to work could be considered more important on a weekday morning than at other times.

The client system can then rank all data and stories based on the Broadcaster Importance, matches to the user profile for Participants, Events, Outcome, and Location, and the Time Sensitivity. In one embodiment of the invention, when users request the information, it is presented to them in sequence, based on the overall importance of the information based on the above.

FIG. 4 shows a news summary screen 301a user might see as a summary of available information in accordance with an embodiment of the invention as an illustrative non-limiting example.

Weather—The system initially shows the current temperature and summary of the weather for today. At this time, the system assumes this is the most important information a users will want. The forecast for tomorrow and the rest of the week are available if the user chooses to explore this content zone, an information portal 302, such as by drilling down with mouse clicks or other methods.

Financial News—The system initially shows index and stock prices listed in the order of user preference. This order may be altered if a significant change in a stock or index price is detected.

Sports—The system initially shows summary information for yesterday and tonight. The football game score from Sunday is available if the user explores this content zone, but it is seem as less important than the baseball game score because it is older.

Traffic—The system initially shows traffic for the Tappan Zee. This is the most likely route the user will take at this time of day on this day of the week. If a significant delay or announcement existed for one of the other user routes, it might be ranked higher than this information.

Headlines—The system shows the two most highly ranked headlines based on the profile, time and broadcaster importance. Users can explore this content zone to see the other headlines.

Events—The system shows events in the near future that are close to the user's home. Events in the past are ranked much lower, because the user cannot attend them.

In addition to seeing summaries for all content zones, users can request individual summaries that overlay on TV programs being viewed. Again, the data and stories are ranked based on what is considered to be the most important to the user.

The signals containing content data can be analyzed remotely or at the local stand-alone system so that relevant information can be extracted and compared to the profile in the following manner.

In one embodiment of the invention, each frame of the video signal can be analyzed to allow for segmentation of the video data. Such segmentation could include face detection, text detection and so forth. An audio component of the signal can be analyzed and speech to text conversion can be effected. Transcript data, such as closed-captioned data, can also be analyzed for key words and the like. Screen text can also be captured, pixel comparison or comparisons of DCT coefficient can be used to identify key frames and the key frames can be used to define content segments.

One method of extracting relevant information from video signals is described in U.S. Pat. No. 6,125,229 to Dimitrova et al. the entire disclosure of which is incorporated herein by reference, and briefly described below. Generally speaking the processor receives content and formats the video signals into frames representing pixel data (frame grabbing). It should be noted that the process of grabbing and analyzing frames is preferably performed at pre-defined intervals for each recording device. For example, when the processor begins analyzing the video signal, frames can be grabbed at a predefined interval, such as I frames in an MPEG stream or every 30 seconds and compared to each other to identify key frames.

Video segmentation is known in the art and is generally explained in the publications entitled, N. Dimitrova, T. McGee, L. Agnihotri, S. Dagtas, and R. Jasinschi, “On Selective Video Content Analysis and Filtering,” presented at SPIE Conference on Image and Video Databases, San Jose, 2000; and “Text, Speech, and Vision For Video Segmentation: The Infomedia Project” by A. Hauptmann and M. Smith, AAAI Fall 1995 Symposium on Computational Models for Integrating Language and Vision 1995, the entire disclosures of which are incorporated herein by reference. Any segment of the video portion of the recorded data including visual (e.g., a face) and/or text information relating to a person captured by the recording devices will indicate that the data relates to that particular individual and, thus, may be indexed according to such segments. As known in the art, video segmentation includes, but is not limited to:

Significant scene change detection: wherein consecutive video frames are compared to identify abrupt scene changes (hard cuts) or soft transitions (dissolve, fade-in and fade-out). An explanation of significant scene change detection is provided in the publication by N. Dimitrova, T. McGee, H. Elenbaas, entitled “Video Keyframe Extraction and Filtering: A Keyframe is Not a Keyframe to Everyone”, Proc. ACM Conf. on Knowledge and Information Management, pp. 113-120, 1997, the entire disclosure of which is incorporated herein by reference.

Face detection: wherein regions of each of the video frames are identified which contain skin-tone and which correspond to oval-like shapes. In the preferred embodiment, once a face image is identified, the image is compared to a database of known facial images stored in the memory to determine whether the facial image shown in the video frame corresponds to the user's viewing preference. An explanation of face detection is provided in the publication by Gang Wei and Ishwar K. Sethi, entitled “Face Detection for Image Annotation”, Pattern Recognition Letters, Vol. 20, No. 11, November 1999, the entire disclosure of which is incorporated herein by reference.

Frames can be analyzed so that screen text can be extracted as described in EP 1066577 titled System and Method for Analyzing Video Content in Detected Text in Video Frames, the contents of which are incorporated herein by reference.

Motion Estimation/Segmentation/Detection: wherein moving objects are determined in video sequences and the trajectory of the moving object is analyzed. In order to determine the movement of objects in video sequences, known operations such as optical flow estimation, motion compensation and motion segmentation are preferably employed. An explanation of motion estimation/segmentation/detection is provided in the publication by Patrick Bouthemy and Francois Edouard, entitled “Motion Segmentation and Qualitative Dynamic Scene Analysis from an Image Sequence”, International Journal of Computer Vision, Vol. 10, No. 2, pp. 157-182, April 1993, the entire disclosure of which is incorporated herein by reference.

The audio component of the video signal may also be analyzed and monitored for the occurrence of words/sounds that are relevant to the user's request. Audio segmentation includes the following types of analysis of video programs: speech-to-text conversion, audio effects and event detection, speaker identification, program identification, music classification, and dialog detection based on speaker identification.

Audio segmentation includes division of the audio signal into speech and non-speech portions. The first step in audio segmentation involves segment classification using low-level audio features such as bandwidth, energy and pitch. Channel separation is employed to separate simultaneously occurring audio components from each other (such as music and speech) such that each can be independently analyzed. Thereafter, the audio portion of the video (or audio) input is processed in different ways such as speech-to-text conversion, audio effects and events detection, and speaker identification. Audio segmentation is known in the art and is generally explained in the publication by E. Wold and T. Blum entitled “Content-Based Classification, Search, and Retrieval of Audio”, IEEE Multimedia, pp. 27-36, Fall 1996, the entire disclosure of which is incorporated herein by reference.

Speech-to-text conversion (known in the art, see for example, the publication by P. Beyerlein, X. Aubert, R. Haeb-Umbach, D. Klakow, M. Ulrich, A. Wendemuth and P. Wilcox, entitled “Automatic Transcription of English Broadcast News”, DARPA Broadcast News Transcription and Understanding Workshop, VA, Feb. 8-11, 1998, the entire disclosure of which is incorporated herein by reference) can be employed once the speech segments of the audio portion of the video signal are identified or isolated from background noise or music. The speech-to-text conversion can be used for applications such as keyword spotting with respect to event retrieval.

Audio effects can be used for detecting events (known in the art, see for example the publication by T. Blum, D. Keislar, J. Wheaton, and E. Wold, entitled “Audio Databases with Content-Based Retrieval”, Intelligent Multimedia Information Retrieval, AAAI Press, Menlo Park, Calif., pp. 113-135, 1997, the entire disclosure of which is incorporated herein by reference). Stories can be detected by identifying the sounds that may be associated with specific people or types of stories. For example, a lion roaring could be detected and the segment could then be characterized as a story about animals.

Speaker identification (known in the art, see for example, the publication by Nilesh V. Patel and Ishwar K. Sethi, entitled “Video Classification Using Speaker Identification”, IS&T SPIE Proceedings: Storage and Retrieval for Image and Video Databases V, pp. 218-225, San Jose, Calif., February 1997, the entire disclosure of which is incorporated herein by reference) involves analyzing the voice signature of speech present in the audio signal to determine the identity of the person speaking. Speaker identification can be used, for example, to search for a particular celebrity or politician.

Music classification involves analyzing the non-speech portion of the audio signal to determine the type of music (classical, rock, jazz, etc.) present. This is accomplished by analyzing, for example, the frequency, pitch, timbre, sound and melody of the non-speech portion of the audio signal and comparing the results of the analysis with known characteristics of specific types of music. Music classification is known in the art and explained generally in the publication entitled “Towards Music Understanding Without Separation: Segmenting Music With Correlogram Comodulation” by Eric D. Scheirer, 1999 IEEE Workshop on Applications of Signal Processing to Audio and Acoustics, New Paltz, N.Y. Oct. 17-20, 1999.

The various components of the video, audio, and transcript text are then analyzed according to a high level table of known cues for various story types. Each category of story preferably has knowledge tree that is an association table of keywords and categories. These cues may be set by the user in a user profile or pre-determined by a manufacturer. For instance, the “New York Jets” tree might include keywords such as sports, football, NFL, etc. In another example, a “presidential” story can be associated with visual segments, such as the presidential seal, pre-stored face data for George W. Bush, audio segments, such as cheering, and text segments, such as the word “president” and “Bush”. After a statistical processing, which is described below in further detail, a processor performs categorization using category vote histograms. By way of example, if a word in the text file matches a knowledge base keyword, then the corresponding category gets a vote. The probability, for each category, is given by the ratio between the total number of votes per keyword and the total number of votes for a text segment.

In a preferred embodiment, the various components of the segmented audio, video, and text segments are integrated to extract profile comparison information from the signal. Integration of the segmented audio, video, and text signals is preferred for complex extraction. For example, if the user desires to select programs about a former president, not only is face recognition required (to identify the actor) but also speaker identification (to ensure the actor on the screen is speaking), speech to text conversion (to ensure the actor speaks the appropriate words) and motion estimation-segmentation-detection (to recognize the specified movements of the actor). Thus, an integrated approach to indexing is preferred and yields better results.

In one embodiment of the invention, system 100 of the present invention could be embodied in a product including a digital recorder. The digital recorder could include a content analyzer processing as well as a sufficient storage capacity to store the requisite content. Of course, one skilled in the art will recognize that a storage device could be located externally of the digital recorder and content analyzer. In addition, there is no need to house a digital recording system and content analyzer in a single package either and the content analyzer could also be packaged separately. In this example, a user would input request terms into the content analyzer using a separate input device. The content analyzer could be directly connected to one or more information sources. As the video signals, in the case of television, are buffered in memory of the content analyzer, content analysis can be performed on the video signal to extract relevant stories, as described above.

While the invention has been described in connection with preferred embodiments, it will be understood that modifications thereof within the principles outlined above will be evident to those skilled in the art and thus, the invention is not limited to the preferred embodiments but is intended to encompass such modifications.

What is claimed is:

1. A method of assembling and processing media content from multiple sources, comprising:
establishing a profile corresponding to topics of interest;
automatically scanning available media sources, selecting a source and extracting from the media source, identifying information characterizing the content of the source;
comparing the identifying information to the profile and if a match is found, indicating the media source as available for access;
automatically scanning available media sources for a next source of media content and extracting identifying information from said next source and comparing the identifying information from said next source to the profile and if a match is found, indicating said next media source as available for access.

2. The method of claim 1, wherein the profile includes geographic and temporal limitations.

3. The method of claim 1, wherein the scanning and comparing steps are repeated until all available media sources are scanned.

4. The method of claim 1, wherein the available sources of media include television broadcasts.

5. The method of claim 1, wherein the available sources of media include television broadcasts and radio broadcasts

6. The method of claim 1, wherein the available sources of media include television broadcasts and website information.

7. The method of claim 1 wherein identifying information is extracted by extracting closed caption information from a video signal.

8. The method of claim 1, wherein identifying information is extracted from screen text.

9. The method of claim 1, wherein identifying information is extracted using voice to text conversion processing.

10. The method of claim 1, wherein the sources of media content are made available at a first location and a user at a second location remote from the first location accesses the available sources of media content.

11. The method of claim 1, wherein one or more of the available media sources are recorded or downloaded and reviewed at a later time.

12. The method of claim 1, wherein topics of interest are selected from the group consisting of sports, weather and traffic.

13. The method of claim 1, wherein media source available for access are compared to determine which source is more timely or complete.

14. The method of claim 1, wherein media sources available for access are priority ranked based on both information obtained from the broadcast and from the profile.

15. A system for creating a set of available media, comprising:
a receiver device constructed to scan and receive signals containing media content;
a storage device capable of receiving and storing user defined profile information;
a processor linked to the receiver and constructed to extract identifying information from a plurality of scanned signals containing media content;
a comparing device constructed to compare the extracted identifying information to the profile and when a match is detected, make the signal containing media content available.

16. The system of claim 15, wherein the receiver, processor and comparing device are constructed and arranged to scan through all media sources scannable by the receiver to compile a subset of available media sources for review, that match the profile.

17. The system of claim 15, including a computer constructed to receive user defined profile information and compare that information to the identifying information to identify matches.

18. The system of claim 15, wherein the receiver is constructed to receive television signals.

19. The system of claim 15, wherein the receiver comprises a first tuner constructed to process television signals and the system further comprising a second tuner constructed to assist in the display of either available media or other media.

20. The system of claim 15 comprising a tuner for processing radio signals.

21. The system of claim 15, comprising a web crawler.

22. The system of claim 15, wherein the receiver, storage device, processor and comparing device are housed within a television set.

23. The system of claim 15, wherein the storage device is constructed and arranged to receive the profile information from a keyboard.

24. The system of claim 15, wherein the storage device is constructed and arranged to receive the profile information for a keyboard from a signal generated when a user performs selected mouse clicks.

25. The system of claim 15, wherein the storage device contains a plurality of selectable predefined profiles.

26. The system of claim 15, wherein the system monitors a user's usage habits and modifies the profile based on those habits.

27. The system of claim 15, wherein the system includes an access screen, presenting both information contained within the accessable content and an access portal for accessing the accessable content.
